(19) United States
(12) Patent Application Publication
(10) Pub. No.: US 2026/0004678 A1
(43) Pub. Date: Jan. 1, 2026

(54) Educational Video Game That Illustrates and Teaches the Mechanics of Double Entry Accounting

(71) Applicant: Patrick Kevin Kohn, St Clair Shores, MI (US)

(72) Inventor: Patrick Kevin Kohn, St Clair Shores, MI (US)

(21) Appl. No.: 18/754,979

(22) Filed: Jun. 26, 2024

(51) Int. Cl. G09B 19/18

(52) U.S. Cl. CPC G09B 19/18

(57) ABSTRACT

This invention assists the new, first time accounting student with understanding the mechanics of double entry accounting by separating the mechanical, physical process of the movement of debits and credit entries by presenting a physics based illustration and then, later, applying accounting values and terminology. It is the opinion of the inventor that attempting to combine the two extremely complicated and different processes into one teaching scenario completely overwhelms most students so that they never really understand a comprehensive overview of how the system works.

### A) INTRODUCTION

Double entry accounting was first conceived in the 13th century by Amalino Manucci in Europe. It was used it to record the books and records of a Flourentine merchant. It's logic and processing have been applied to all accounting systems and software applications since that time to the current day on a worldwide basis. Its logic and application are taught globally in high schools and colleges. The current educational methods attempt to illustrate the logic of the how double entry accounting flows by labeling and quantifying financial transactions and recording a series of debits and credits in a simple or complex that financial results can be accumulated and summarized and used for making business decisions and also for tax reporting. Searching the internet for images of double entry accounting results in thousands of unique, different views of how the process works. Each image is uniquely different, each image is an interpretation of the author's own perception of how the process works. The ironic and confusing dilemma is that—how can one common and universally used concept produce thousands of images if they are all about the same single concept? This confusion results in tremendous difficulty in teaching the concept of double entry accounting in both high schools and colleges and causes a very high class dropout rate. The students that do complete the classes end up memorizing a series of rules and guidelines and never really understand how the system works on an overview basis and have no genuine perspective of how the process actually works and produces business records. The long term impact in an individual's career severely limits the ability to effectively apply the accounting process and ultimately diminishes their long term career growth opportunity.

### B) THE REASON FOR THIS NEW APPROACH AND HOW IT WILL ASSIST THE EDUCATION PROCESS OF TEACHING DOUBLE ENTRY ACCOUNTING

There are two unique, totally different, complicated logic systems that create double entry accounting
1) Scientific/Physics Visual Logic System of Moving Objects

The balancing logistics of how gravity and inertia interact and are affected by the movement of other balancing components within the same logic system
2) The Concept of Accounting and All of Its Components

The use of debits, credits, general ledgers, balance sheets, assets, liabilities, equities, cash flow modeling, budgeting, projections, etc.

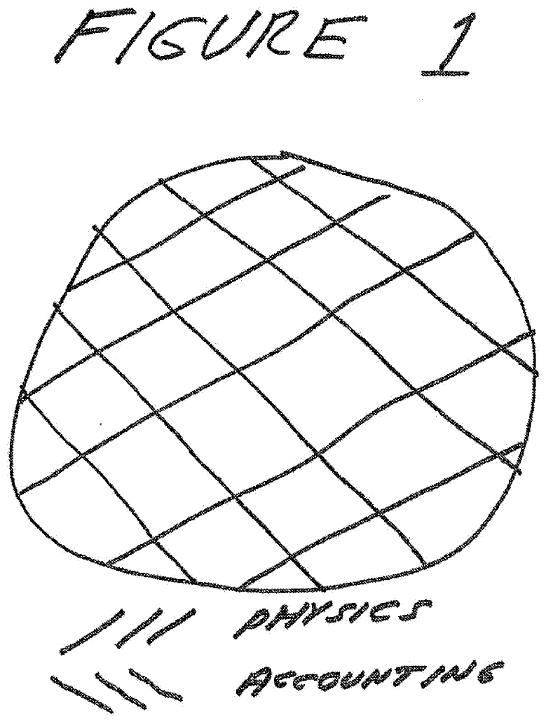

FIG. 1 shows the rationale for how this topic is currently taught to students of accounting

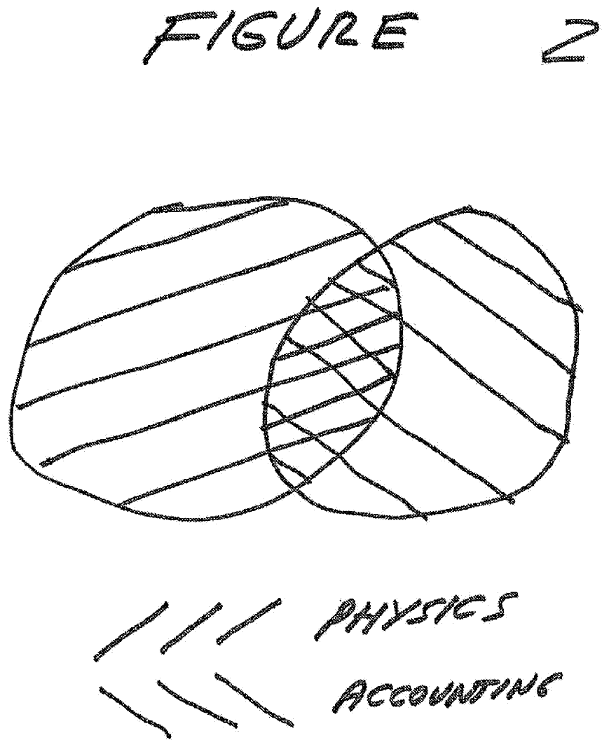

FIG. 2 shows a modified proposed approach which clearly distinguishes the two systems as separate entities and then uses the visual challenge of a video game to separate two systems and phases the scientific approach into the financial approach.

KEY POINT HERE: TEACHING THE TWO CONCEPTS SIMULTANEOUSLY TOTALLY OVERWHELMS. THE STUDENT LEARNER AND RESULTS IN AN INEFFECTIVE LEARNING APPROACH, THE TWO CONCEPTS NEED TO BE INTRODUCED SEPARATELY AND THEN STRATEGICALLY BLENDED TOGETHER TO PROPERLY TEACH THE CONCEPT IN AN EFFICIENT MANNER

### C) EXPANSION OF THE SCIENTIFIC/PHYSICS VISUAL LOGIC SYSTEM OF MOVING OBJECTS

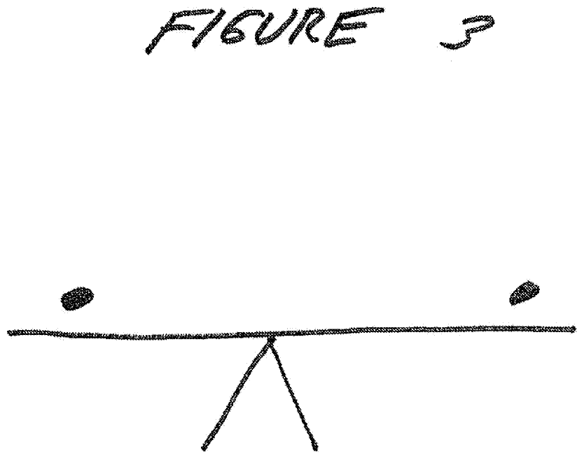

FIG. 3 shows a simple balance beam model with two equivalent widgets, one on each side of the balance beam

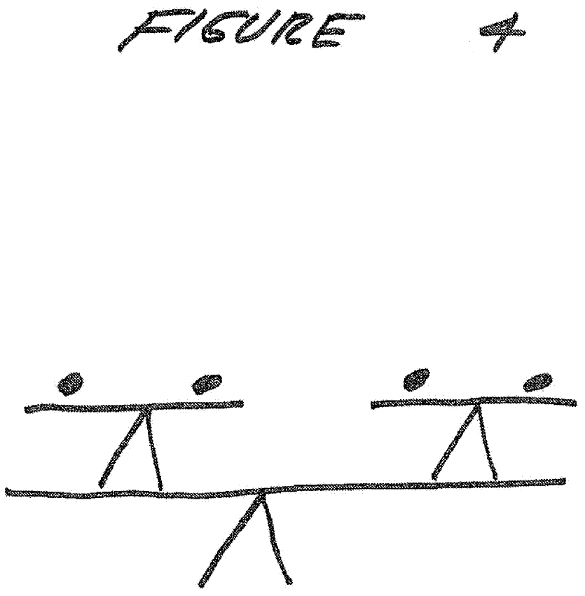

FIG. 4 shows FIG. 3 with two additional, identical, smaller balance beams mounted on top of the larger beam

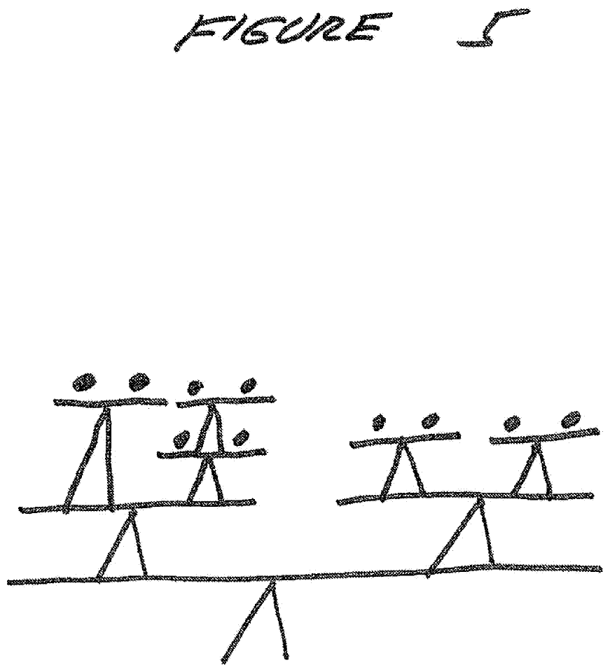

FIG. 5 shows the more complex balance beam that will be used in the video game model

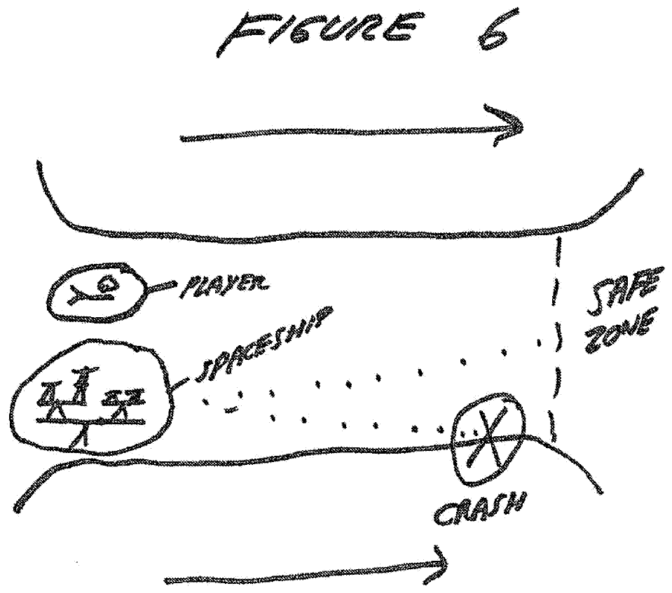

FIG. 6 shows the natural physical landscape that will be used in the video game to bring FIG. 6 to life as a spaceship, in motion, moving from felt to right through a corridor in space.

### D) ILLUSTRATION OF HOW VIDEO GAME IS PLAYED

Rules of the Game:
1) Using FIG. 6 as a background of the physical landscape of the platform of the view that will appear on the players screen, FIG. 5 will become a spaceship that travels from tell to right through the open corridor.
2) The spaceship is on a trajectory that will cause It to crash fand into the earth before it leaves the open channel to the right. As long as all the beams in the spaceship are horizontal, the space ship will continue to move from fell to right on its planned trajectory.
3) The game player will be located above the spaceship In an airplane and travel through the corridor just above the spaceship. The airplane contains 10 equal weight pods that must be relocated onto the spaceship receptors prior to the the spaceships planned crash landing. If the pods are not relocated by the lime the spaceship reaches it's destination, the spaceship with crash and explode the entire earth as well as the game player's airplane. The pods can only be placed one at a time.
4) The player will use a joy stick or mousepad to relocate the pods onto the spaceship.
   Explanation of How The Spaceship's Balance Beams Move and Interact when Pods are Placed:

Each pod is placed on one of the ten (10) open positions throughout the game. When the first pod is placed (along with all the odd numbered pods 3, 5, 7, 9), the spaceship will either tilt forward or backward and cause the spaceship to dragged by gravity closer to the earth which would cause it to crash into to the earth well before the players time is up. When each even numbered pod is placed, by design, the spaceship rebalances and the gravity affect is negated and the spaceship continues horizontally (pods, 2, 1, 6, 8, 10). All balance beams begin the game as GREEN and as pods are placed In the receptors, become individually imbalanced and change to RED and remain RED until the the necessary pods are placed to rebalance the beam and it goes back to green.

### E) STEP BY STEP GAME OPERATION—LET THE GAME BEGIN!!!

### Screen View at Start of Game

The view of the screen at the start of the game is a natural setting with blue sky, moving clouds, birds and trees is the background. The spaceship and the player's airplane will enter the view from the left side of the screen, in the larger open area and then enter the corridor in the middle of the screen

### Game Rules

1) Game duration is exactly five (5) minutes
2) There will be an announcer throughout the 5 minutes that will be imploring the airplane/player to expediently relocate the pods from the helicopter onto the spaceship as quickly as possible to save the earth from its ultimate destruction
3) There will be intentional obstacles (think “frogger”) that will cause delays in transferring the pods onto the spaceship, such as flying creatures, storms and such.
4) IMPORTANT TO NOTE: Each time a pod is being placed onto the spaceship from the helicopter, the screen will freeze and expand so that the 5 minute clock STOPS and the player watches how the placement of the pod affects the motion and interaction of the balance beams.

### Chronological Game Operation

A) The game starts . . . 5:00 . . . 4:59 . . . etc.
B) The airplane/player and spaceship move in tandem from the large opening on the left into the corridor from left to right toward the middle of the screen, it is now down to 4:40
C) The announcer informs the airplane/player (by name), that they need to lower one of the 10 pods from the helicopter ono one of the 10 open receptors on the spaceship, it is now 4:20
D) The player grabs the pod and lowers it onto any of the 10 open receptors, it is now 4:00
E) The spaceship and time FREEZE and the spaceship enlarges to fill the whole screen, time is now stopped at 4:00
F) The spaceship beam which receives the pod now tilts to the left or right and a sequence of related beam movements occur which cause the very bottom beam to be lowered to the left or right which causes the descent of the spaceship toward earth to accelerate. It Is still 4:00
G) The announcer pleads to the player to place another pod on the opposite side of the pod that was just placed. The player places a pod on ANY of the receptors on the OPPOSITE side of where the first pod was placed.
H) The beams now move again in a sequence which causes the very bottom beam to rebalance and the accelerated descent to the earth is eliminated. The spaceship shrinks away and we are now back to the full view of the panorama and the clock restarts, 4:00 . . . 3:59 . . .
I) The scenario described in letter H repeats nine (9) more times and the player views each different possible combination of beam movements and subliminally memorizes the pattern of how the beams move and begins to anticipate their movement.

Fast forward . . . there are 10 seconds left, the spaceship is about to hit the earth, the final pod is being placed onto the spaceship but BY DESIGN, it doesn't make it in time and the earth EXPLODES and the spaceship and helicopter EXPLODE and it's the end of the world!!!
K) OK, “let's play again”, the student/player starts over and watches again, many, many more times until the pattern of balance beam movements is memorized and then finally wins the game and is ready for first accounting class.

By Design, The Player Will Lose 50 Times Before Winning

The reason that the player will lose is so that the movement of the pods and balance beams is subliminally memorized. The accounting model version of the game's spaceship is IDENTICAL to the spaceship and the smooth transition between the logic of the video game and the processing of accounting debits and credits is seamless.

### F) FIRST ACCOUNTING CLASS—THE LIGHT GOES ON!!!

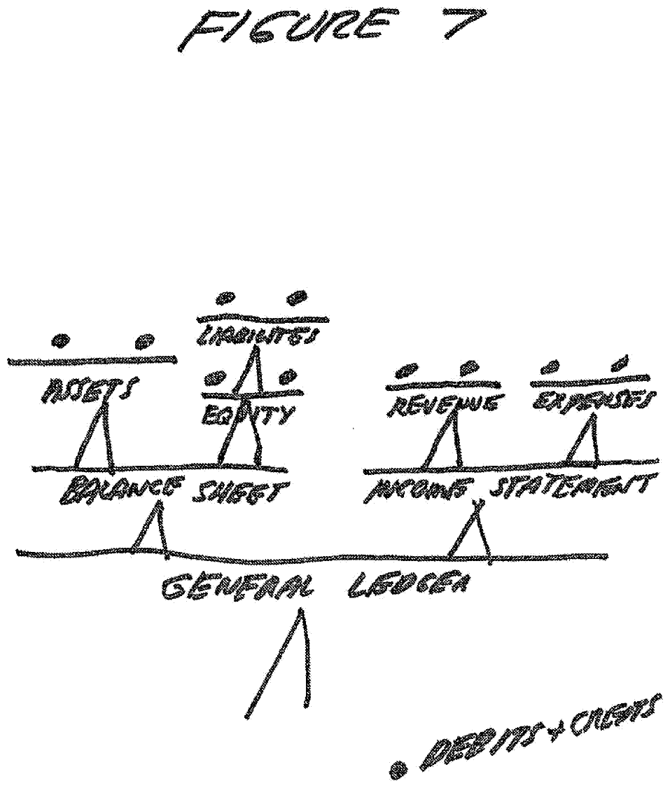

FIG. 7 associates the basic, universal primary accounting categories/labels to the spaceship balance beams and reveals that the pods are debits and credits. This Figure links the logic of physical movement with the technicalities of double entry accounting and seamlessly blends the two logic systems into one like no other teaching method ever has.

### G) CONCLUSION

Due to the current teaching methods used for beginning accounting students, which attempt to combine both the physical logic of how quantifiable values balance along with all the complexities of the accounting cycle and all of its terminology and components, the student is overwhelmed and does not truly capture the overall perspective of how these two systems blend together to produce financial results.

Most students leave college with little or no understanding of the overall perspective of how double entry accounting processes information. They will generally evolve into a work environment that limits their accounting processing to one or a few transaction which becomes their entire career and are never knowledgeable or curious enough to venture outside of that little “world”. Sort of like a mouse who enters the maze in search of the block of cheese at the end of the maze but finds crumbs in a few corners on the way and is happy enough with that and never makes it through the maze to the “ultimate” goal.

The blended approach, which firstly illustrates the mechanics of physical balancing using balance beams and pods, then secondly blends the logic of accounting terms and processes into the mechanics is far more logical and makes it easier for the student to assimilate the complete overview of the accounting process. The mouse no longer finds crumbs and is complacent with selling for a comfortable location in the maze but is now empowered to mice through the maze, locate the large block of cheese and the end of the maze and is ready to do it again and again!!! This approach is a total game changer and is unique and a very valuable method in learning technology and all of its logistics and processes.

I claim:

1. A process comprising assisting a beginning accounting student with understanding mechanics of double entry accounting by illustrating it in simple terms using a video game that contains no dollar values or accounting terminology and then, in a second step, applying dollar values and accounting terminology for a more presenting a physics based illustration and then, later, applying accounting values and terminology. The video game, prototype has already been created and is available for viewing by the examiner and was prepared by a professional gaming producer and fully illustrates the inventors creation at a cost of $4,000.00.
